(19) United States
(12) Patent Application Publication
(10) Pub. No.: US 2018/0072963 A1
(43) Pub. Date: Mar. 15, 2018

(54) Chemical Additive for Reclaiming Oil From A Product Stream

(71) Applicant: Applied Material Solutions, Inc., Elkhorn, WI (US)

(72) Inventors: Travis Hale, Elkhorn, WI (US); Robert Scobell, Arlington Heights, IL (US); Sean Skweres, Kenosha, WI (US)

(73) Assignee: Applied Material Solutions, Inc., Elkhorn, WI (US)

(21) Appl. No.: 15/263,680

(22) Filed: Sep. 13, 2016

(51) Int. Cl. C11B 3/00; B01D 11/04; B01D 17/04

(52) U.S. Cl. CPC C11B 3/001; B01D 17/047; B01D 11/0492

(57) ABSTRACT

A chemical additive for reclaiming oil from a fluid product stream is described. In embodiments, chemical additive compositions comprise a propylene glycol ester, a hydrophobic silica, a polyglycol ester or a polyglycerol oleate ester, a polyethoxylate sorbitan or sorbitan ester and a block copolymer or ethylene oxide-propylene oxide polymer. Less chemical additive is needed for improved oil extraction and concentration and a shorter incubation time is required, which reduces cycle time and energy consumption.

### FIELD

The field is related generally to chemical additive compositions and, more particularly, to a chemical additive for reclaiming oil from a fluid product stream.

### BACKGROUND

Oil production, whether it is mineral/hydrocarbon or vegetable, has many natural processing variables. One limiting factor is the concentration of water emulsified within the oil itself. All naturally derived oil sources contain some amount of water. This water is detrimental to most end uses of the oil or to further chemical or physical processing. Therefore, there is critical need to remove the water from the oil.

Initially mechanical methods for removable were invented such as decanting, boiling, centrifuging, or combinations. As effective as these methods have been, water concentrations within the oil, still remain. Chemical additives were invented as a result to supplement and enhance the mechanical methodologies, which can be seen in the prior art. Some examples of such prior art are: U.S. Pat. Nos. 4,029,596; 6,201,142; 8,192,627; 8,841,469 and 8,962,059.

Prior art in this field relies on chemically weakening the micelle strength encapsulating the water within the oil, with or without, a physical rupturing of the micelle by a solid particle dispersed within. Thus, the water is released from suspension and able to be more readily extracted by traditional mechanical means noted above. Applicant's inventive additive takes these principles and extends the theory to optimize efficiency within the temperatures that water extraction typically takes place, optimize the physical assault on the micelle barrier by specifying particle sizes, and optimize the viscosity of the additive itself to allow for greater fluidity and dispensability. Higher efficiency and lower average water content of the resulting oil after mechanical separation are the results.

A substantial advantage over the prior art is that applicant's invention allows for comparable oil/water separation to prior art using 15-20% less additive. Applicant's invention uses a range of surfactants and esters. The prior art has been heavily reliant on Poly 80 technologies. Trans-esters in addition to PEG esters are used. Additionally, polyol esters (ex. L-101 esters, L-64 esters and similar), polyglycerol esters, ethoxilated glucose and esters there of (ex. PEG 120 Glucose Ester).

Wide varieties of chemical additives for oil/water separation have been created and are available. However, there is a need for improvement of chemical additives efficiency, and it is to this need that this invention is directed.

### SUMMARY

The present inventors seek to solve the problem of providing an effective and energy efficient chemical additive for reclaiming oil from fluids. Chemical additives of the type described herein can be formulated for multiple different uses such as for corn oil extraction, vegetable oil purification/processing, concentrating gluten, and fish oil extraction. Treatment of the application is also discussed. Treatment methods will account for concentration level, injection or dispersal methods, pH, water content, salinity and nominal droplet size.

In embodiments, a chemical additive for reclaiming oil from a fluid product stream comprises a propylene glycol ester, a hydrophobic silica, a polyglycol ester or a polyglycerol oleate ester, a polyethoxylate sorbitan or sorbitan ester and a block copolymer or ethylene oxide-propylene oxide polymer. Other constituents may be added as described herein. Dewatering is enhanced in this process due to the treatment's strong attraction to oil/water interface, increased flocculation, promotion of coalescence and wetting solids. The main benefit of the present invention is that less chemical additive is needed for improved oil extraction and concentration and a shorter incubation time is required, which reduces cycle time and energy consumption.

In embodiments, the chemical additive composition comprises 100 parts. The additive contains propylene glycol ester preferably provided in an amount of 5-20%, hydrophobic silica of at least 10-30%, polyglycol ester or a polyglycerol oleate ester at 5-15%. Polyethoxylate sorbitan or sorbitan ester is preferably provided in an amount of about 10-30%. A block copolymer or ethylene oxide-propylene oxide polymer is preferably provided in an amount of about 50-90%. It is highly preferred that less chemical additive is needed for improved oil extraction and concentration and a shorter incubation time is required which reduces cycle time and energy consumption.

Other preferred embodiments of the chemical additive for reclaiming oil from a fluid product stream include propylene glycol ester at 5-20%, hydrophobic silica of at least 10-30%, polyglycol ester or a polyglycerol oleate ester at 5-15%, polyethoxylate sorbitan or sorbitan ester at 10-30%; and a block copolymer or ethylene oxide—propylene oxide polymer at 50-90%.

Still another preferred embodiment of the chemical additive includes a hydrophobic silica of at least 10-20%, paraffinic solvent such as 1,2-ethanediol or 1,2-propanediol at 30-60%, polyglycerol ester or a polyglycerol oleate ester at 5-25%; polyethoxylate sorbitan or sorbitan ester at 5-15%; and a block copolymer or ethylene oxide—propylene oxide polymer at 50-90%.

It is also preferable that the chemical additive includes a carrier solvent to control the viscosity of the chemical additive. Preferably, the carrier solvent is either Low Odor Paraffinic Solvent, corn oil or water. It is also preferred that carrier solvent is at least partially compatible with the fluid product stream.

In highly preferred embodiments, the hydrophobic silica is precipitated, fumed and/or gel silica produced in a dry roast process using silicone agents or wax.

Vegetable oil, polyol, polyol esters and PEG esters are used in conjunction with polyglycol esters in preferred embodiments. It is also preferred that the chemical additive include a glucose derived material and glycerin as well as sodium lauryl sulfate.

Highly preferred embodiments include Tri-Glycerol Mono-Oleate to improve water separation. Preferably, higher concentrations of ester prove effect for higher temperatures. Concentrations of polyglycol ester at 15-32% are advantageous for use with higher temperatures above 100-150 Celsius.

Methods of manufacture and use are within the scope of the invention.

### BRIEF DESCRIPTION OF THE DRAWINGS

The drawings illustrate a preferred embodiment including the above-noted characteristics and features of the invention. The invention will be readily understood from the descriptions and drawings. In the drawings:

FIG. 1 is a simplified flow diagram of an oil/water separation process in which a demulsifying chemical additive is introduced without a retention vessel; and

FIG. 2 is a simplified flow diagram of an oil/water separation process in which a demulsifying chemical additive is introduced with a retention vessel.

### DETAILED DESCRIPTION

Exemplary chemical additive for reclaiming oil from fluid product stream compositions, methods of making the chemical additive, and applications of such chemical additive will now be described in detail with respect to the detailed description and examples that follow. The preferred embodiments described herein are not intended to be exhaustive or to limit the invention to the precise forms disclosed. The section headings provided herein are for convenience only and are not intended to limit the scope of the invention in any way.

### Definitions

“A” or “an” means one or more.

“About” means approximately or nearly, and in the context of a numerical value or range set forth herein, means±10% of the numerical value or range recited or claimed.

“Admix” means to mix or blend.

“AMulSion™” is the trademark used by applicant for the chemical additive that is the subject of this application.

“Copolymer” means or refers to any polymer synthesized from two or more different monomers using various polymerization techniques. For example, each of (1) polyester made from a dicarboxylic acid, a diol and phosphoric acid and (2) a polyester made from a dicarboxylic acid and a diol is a copolymer.

“Decant” means or refers to gently pouring a liquid so as not to disturb the sediment.

“Dewatering” means or refers to the physical removal of water from the product stream.

“Emulsion” means or refers to when droplets of one liquid are dispersed and suspended within another immiscible liquid.

“Molecular weight” means or refers to the weight average molecular weight of a polymer.

The phrase “parts per hundred parts resin” or “PHR” means or refers to an assigned value of 100 for the mass of the resin component of the composition with all other constituents given as a fraction of the mass of the resin component.

“Polymer” means or refers to large molecules with repeating smaller molecules known as monomers. A combination of one or more monomeric unit can also result in the formation of a (co)polymer.

“Polyol” means or refers to any organic compound having two or more hydroxyl or active hydrogen groups such as, for example, diols and triols.

As used herein, the term “wt. %” means or refers to percent by weight.

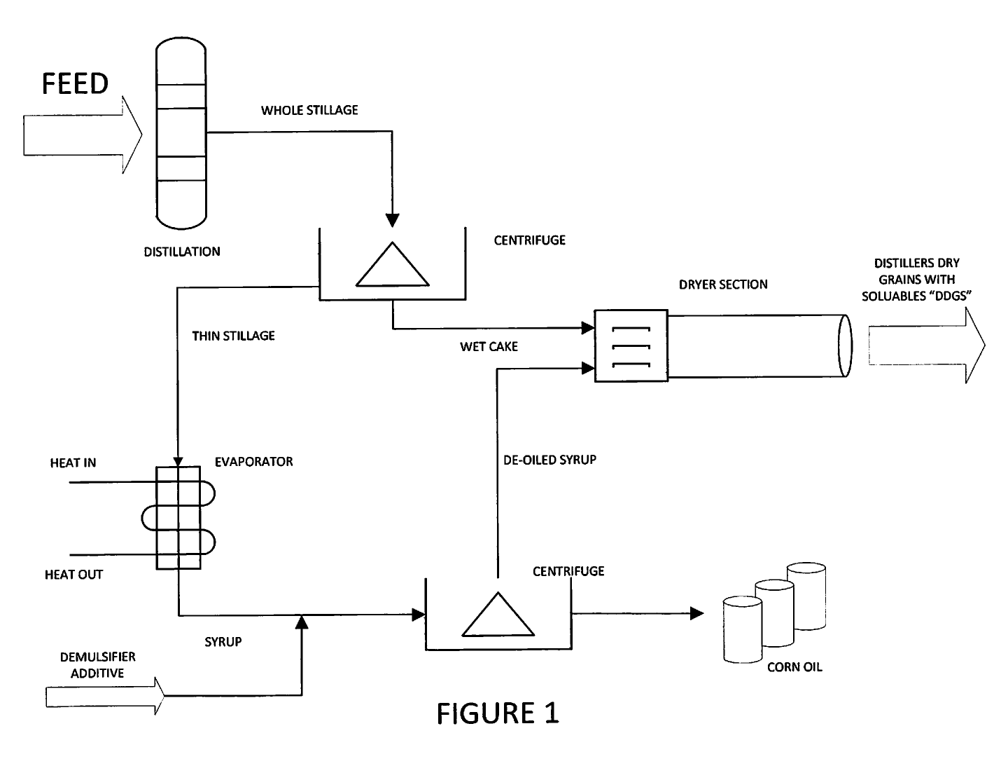

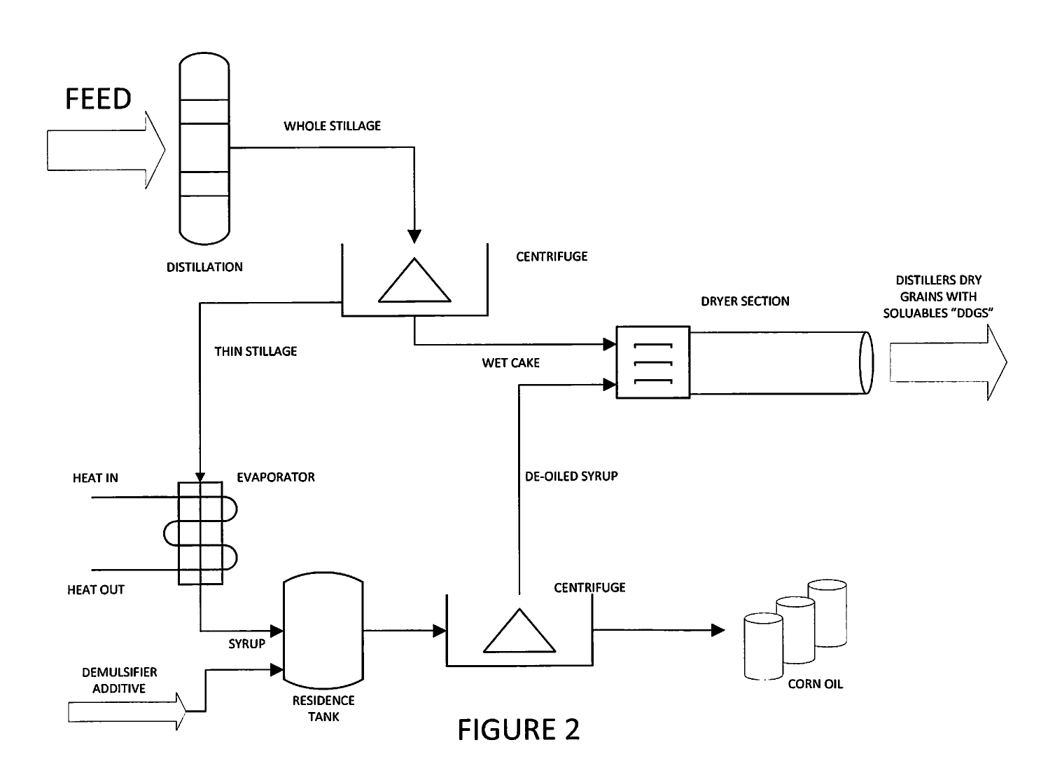

As noted above, and also in FIGS. 1 and 2, the formulated chemical additive for reclaiming oil from fluid product stream compositions increases the oil/water separation rate and efficiency when added in small discrete amounts. Separation enhancement is achieved by modifying the surface tension of the water and the inter-phasic surface tension thereby destabilizing the liquid-liquid suspension and promoting coalescence. A multi-layered liquid is created that has a very low residual oil content within the water phase and a very low concentration of remaining water and associated salts in the oil layer. The water and salt content can then be decanted or removed by other similar processes. Doing so concentrates the oil to the specifications required by the refinery or processor.

The chemical additive for reclaiming oil from a fluid product stream includes propylene glycol ester at 5-20%, hydrophobic silica of at least 10-30%, polyglycol ester or polyglycerol oleate ester at 5-15%, polyethoxylate sorbitan or sorbitan ester at 10-30% and a block copolymer or ethylene oxide-propylene oxide polymer at 50-90%.

Another embodiment of the chemical additive for reclaiming oil from a fluid product stream include propylene glycol ester at 5-20%, hydrophobic silica of at least 10-30%, polyglycol ester or a polyglycerol oleate ester at 5-15%, polyethoxylate sorbitan or sorbitan ester at 10-30%; and a block copolymer or ethylene oxide—propylene oxide polymer at 50-90%.

Still another embodiment of the chemical additive includes a hydrophobic silica of at least 10-20%, paraffinic solvent such as 1,2-ethanediol or 1,2-propanediol at 30-60%, polyglycerol ester or a polyglycerol oleate ester at 5-25%; polyethoxylate sorbitan or sorbitan ester at 5-15%; and a block copolymer or ethylene oxide—propylene oxide polymer at 50-90%.

One of the main advantages of the present additive is that less chemical additive is needed for improved oil extraction and concentration and a shorter incubation time is required which reduces cycle time and energy consumption. The main applications for the chemical additive are for corn oil extraction, vegetable oil purification and processing, concentrating gluten and fish oil extraction.

The chemical additive provides oil separation from other products and shows a marked decrease in the retention time before centrifuging. This is quite advantageous as it allows users to significantly reduce resonance time at elevated temperatures and this results in an overall increase in the capacity of the recovery unit as well as a reduction in energy cost per unit of oil recovered from the reduced hold time at elevated temperatures. These advantages are due in part to the inventive additions of polyethoxy-sorbitans and sorbitan esters in conjunction with the hydrophobically-treated silica(s).

The chemical additive includes a carrier solvent to control the viscosity of the chemical additive. Such carrier solvent is either Low Odor Paraffinic Solvent, corn oil or water. When selecting a carrier solvent it is important that the carrier solvent is at least partially compatible with the fluid product stream.

The hydrophobic silica used in the additive is precipitated, fumed and/or gel silica produced in a dry roast process using silicone agents or wax. Vegetable oil, polyol, polyol esters and PEG esters can be used in conjunction with polyglycol esters for improved performance. A glucose derived material and glycerin are also used for the purpose of increase water solubility. Furthermore, tri-glycerol and mono-oleate can be used in the additive to improve water separation. Higher concentrations of polyglycol ester at about 15-32% are advantageous for use with higher temperatures, namely temperatures above 100-150° Celsius.

This present application includes many improvements over the prior art. Some of these improvements over the prior art are the following.

It is novel to use hydrophobic silica at 10-30 wt % in such a process. It is also novel to use a proprietary silica treatment to make it hydrophobic. Specifically the “dry roasting” process provides high levels of hydrophobicity using PDMS, HMDZ, DMSO, PDMS-MQ, DMDCl, Carnuba Wax, and/or Bee's Wax. Additionally, applicant's proprietary treatment allows for control of the degrees of hydrophobicity as determined by the Wacker Chemie reference, the Nottingham Bench Test or similar methods to describe the percent of particle coverage or categorizing the degree of hydrophobicity on the +2/+1/0/−1/−2 scale. “In-Situ” processes will not provide adequate performance as the process itself inhibits the ability to characterize the degree of hydrophibicity.

Applicant also controls the particle size ranges including the average particle size, size distribution, and/or the addition of one or more sized particles is matched to the application. Lower temperature applications call for lower SSA whereas higher temperature applications require higher SSA particles.

A substantial advantage over the prior art is that applicant's invention allows for comparable oil/water and uses 15-20% less additive than competitors. Applicant's invention uses a range of surfactants and esters. The prior art is heavily reliant on Poly 80 technologies. In contrast, application uses trans-esters in addition to PEG esters are used. Additionally, polyol esters (for example, such as L-101 esters, L-64 esters and similar), polyglycerol esters, ethoxilated glucose and esters thereof (for example, PEG 120 Glucose Ester). These particles are silica-fumed, silica-precipitated, silica-gels. These articles allow for the particle size range variations needed to provide improved performance. In some situations, a multimodal distribution is required for extreme separations and or cases where there are higher levels of contamination in the stillage.

When using hydrophobic silica at 10-30 wt % it is necessary to use carrier solvents that help control the viscosity of these higher solids loadings. Thinning oils like LOPS (Low Odor Paraffinic Solvent) (one such example is LPA 210) is used to maintain a fluid viscosity more suitable for pumping and internal distribution within the stillage. Without such a thinning agent, the additive of the invention would be less effective due to poor or more difficult blending within the stillage. Only adequate distribution of the additive will result in improved separation/yields as shown by the invention. It is also important that the thinning agent be compatible or partially compatible with one of the fluids being separated. For example, in processes for corn oil extraction as the goal, a thinning agent of processed corn oil would be used. Sodium Lauryl Sulfate is an additive used in applicant's invention to improve performance in some applications.

The chemical additive allows for shorter residence time in incubation. Shorter residence time reduces the cycle time thereby increasing the overall total capacity of the unit. Shorter residence time also equates to less energy needed for incubation thereby decreasing the cost per unit processed.

In natural oil emulsion processes, the chemical additive can provide comparable results (percentage oil recovered, percentage water removed, etc.) with less additive needed to get such results. Additive rates to crude or raw stillage are 2%-35% lower than conventional additives when compared. The chemical additive allows for conversion of typical dewatering or emulsion, thereby breaking units to this product with minimal changes to the process. The chemical additive allows for a smaller amount of additive that is needed which lowers the average cost of a gallon recovered or dewatered. The chemical additive also provides a cleaner separation of the emulsion and less residual unwanted content in each segment of the broken emulsion occurs. Dosage rates of the chemical additive are typically 440-700 ppm (parts per million) of the stillage or raw crude feed on a weight basis.

Applicant's testing procedure is detailed below as well as the results. Applicant's chemical additive has three main formulas that are noted in the chart below under its trademark, specifically as AMulSion™ COD-1, AMulSion™ COD-2 and AMulSion™ COD-3. AMulSion™ COD-3 is claimed in the claim set of this application.

Testing Procedure was as follows: Heat a 100-gram sample of syrup to 212° F. Dose the sample with the additive, shake for 10 seconds to disperse the additive fully, and hold at temperature for 30 minutes. At the end of the hold time, fill 50 ml centrifuge tubes with the treated syrup and centrifuge at 3500 rpm for 10 minutes. Remove the tube and measure the height of the separated oil from the remaining solids and stillage.

Performance Testing Versus Competitive Samples:

| | mm of oil separation | | | | |
|---|---|---|---|---|---|
| | Sample | Sample | Sample | Sample | |
| Formula | 1 | 2 | 3 | 4 | Average |
| AMulSion ™ COD-1 | 5.0 | 5.0 | 5.0 | 5.0 | 5.0 |
| AMulSion ™ COD-2 | 4.0 | 2.5 | 4.0 | 2.5 | 3.3 |
| AMulSion ™ COD-3 | 4.0 | 4.0 | 2.5 | 3.0 | 3.4 |
| Competitor A | 2.0 | 3.0 | 3.5 | 2.0 | 2.6 |
| Competitor B | 4.0 | 3.5 | 5.0 | 4.0 | 4.1 |

In conclusion, the invention significantly outperforms the leading competitive additives.

In the next test, the following procedure was utilized when testing the invention versus base chemicals. Heat a 100-gram sample of syrup to 212° F. Dose the sample with the additive, shake for 10 seconds to disperse the additive fully, and hold at temperature for 30 minutes. At the end of the hold time, fill 50 ml centrifuge tubes with the treated syrup and centrifuge at 3500 rpm for 10 minutes. Remove the tube and measure the height of the separated oil from the remaining solids and stillage.

Performance Testing Versus Base Chemicals

| | mm of oil separation | | |
|---|---|---|---|
| | Sample | Sample | |
| Formula | 1 | 2 | Average |
| AMulSion ™ COD-l | 6 | 7 | 6.5 |
| AMulSion ™ COD-2 | 6 | 7 | 6.5 |
| DGDO | 3 | 2 | 2.5 |
| TGMO | 4 | 3 | 3.5 |
| 10-1-O | 7 | 6 | 6.5 |
| 10-1-CC | 5 | 6 | 5.5 |
| Blank | 1 | 1 | 1.0 |

In conclusion, the invention equals or outperforms other base chemical additives.

In the next test, variants of the same chemical composition were tested. The testing procedure was as follows: Heat a 100-gram sample of syrup to 212° F. Dose the sample with the additive, shake for 10 seconds to disperse the additive fully, and hold at temperature for 30 minutes. At the end of the hold time, fill 50 ml centrifuge tubes with the treated syrup and centrifuge at 3500 rpm for 10 minutes. Remove the tube and measure the height of the separated oil from the remaining solids and stillage.

Performance Testing Versus Variants of the Same Chemical Composition

| | mm of oil separation | | |
|---|---|---|---|
| | Sample | Sample | |
| Formula | 1 | 2 | Average |
| AMulSion ™ COD-1 | 6 | 7 | 6.5 |
| AMulSion ™ COD-2 | 6 | 6 | 6.0 |
| Blank | 2 | 3 | 2.5 |
| COD-1L | 5 | 5 | 5.0 |
| COD-2L | 5 | 5 | 5.0 |
| COD-2L-6 | 5 | 5 | 5.0 |

In conclusion, the additive that is the subject of this application proves to be the most effective composition based on oil separation.

FIG. 1 illustrates a simplified flow diagram of an oil/water separation process in which a demulsifying chemical additive is introduced without a retention vessel. In contrast, FIG. 2 illustrates the same process; however, a retention vessel is present.

Wide varieties of materials are available for the various parts discussed and illustrated herein. While the principles of this invention and related method have been described in connection with specific embodiments, it should be understood clearly that these descriptions are made only by way of example and are not intended to limit the scope of the application. It is believed that the invention has been described in such detail as to enable those skilled in the art to understand the same and it will be appreciated that variations may be made without departing from the spirit and scope of the invention.

1. A chemical additive for reclaiming oil from a fluid product stream comprising:
a hydrophobic silica of at least 10-20%;
a paraffinic solvent such as 1,2-ethanediol or 1,2-propanediol at 30-60%;
a polyglycerol ester or a polyglycerol oleate ester at 5-25%;
a polyethoxylate sorbitan or sorbitan ester at 5-15%; and
a block copolymer or ethylene oxide—propylene oxide polymer at 50-90%.
wherein less chemical additive is needed for improved oil extraction and concentration and a shorter incubation time is required which reduces cycle time and energy consumption.

2. The chemical additive of claim 1 further including a carrier solvent to control the viscosity of the chemical additive.

3. The chemical additive of claim 2 wherein the carrier solvent is either Low Odor Paraffinic Solvent, corn oil or water.

4. The chemical additive of claim 3 wherein carrier solvent is at least partially compatible with the fluid product stream.

5. The chemical additive of claim 1 wherein the hydrophobic silica is precipitated, fumed and/or gel silica produced in a dry roast process using silicone agents or wax.

6. The chemical additive of claim 1 wherein vegetable oil, polyol, polyol esters and PEG esters are used in conjunction with polyglycol esters.

7. The chemical additive of claim 1 further including a glucose derived material and glycerin.

8. The chemical additive of claim 1 further including sodium lauryl sulfate.

9. The chemical additive of claim 1 wherein the additive is used for corn oil extraction, vegetable oil purification and processing, concentrating gluten and fish oil extraction.

10. The chemical additive of claim 1 wherein concentrations of polyglycol ester at 15-32% are advantageous for use with higher temperatures above 100-150 Celsius.

11. The chemical additive of claim 1 further including tri-glycerol and mono-oleate to improve water separation.

12. The chemical additive of claim 1 wherein the paraffinic solvent provides a mineral oil carrier for actives and maintains a fluid viscosity enabling ease of addition and to make the additive more dispersible.
